(19) United States
(12) Patent Application Publication
(10) Pub. No.: US 2005/0224610 A1
(43) Pub. Date: Oct. 13, 2005

(54) Pulper rotor and assembly

(76) Inventors: John J. Egan III, Centerville, OH (US); Donald J. Greier, Dayton, OH (US)

Correspondence Address: WEGMAN, HESSLER & VANDERBURG, 6055 ROCKSIDE WOODS BOULEVARD, SUITE 200, CLEVELAND, OH, 44131, US

(21) Appl. No.: 10/495,814

(22) PCT Filed: Jan. 13, 2004
(86) PCT No.: PCT/US04/00791

§ 371 Date: Apr. 14, 2005

(51) Int. Cl. B02C 23/36

(52) U.S. Cl. 241/46.17

(57) ABSTRACT

An improved pulper, mixer or defibering, rotor having a spar ring attached to a hub of the rotor with a series of curved vanes projecting from the spar ring. The curved vanes have a vane face and a trailing edge. The trailing edge may be unitary and integral with the vane, or may be segmented in combination with trailing edge portion provided on an underlying spar stub to which the vanes are attached. The hydrodynamic suction created by the trailing edge is enhanced by the addition of a dam at the vane tip end of the trailing edge zone. The vanes have a constant vane face angle relative to radians extending outward from the hub of the rotor. As a result of the constant vane face angle the pulp, or other materials, mixed by the vanes during rotation of the rotor are more consistently in contact with the vanes during rotation of the rotor. The vanes are also streamlined to reduce hydrodynamic drag especially at the vane tips where speed and therefore drag potential are at their highest levels. As a result, increased circulation and pumping effects with minimal power requirements are achieved. The vanes may be made of high wear resistant materials and are easily accessible for maintenance, repair or replacement.

### CROSS-REFERENCE TO RELATED APPLICATION

This application claims the priority benefit of U.S. Provisional Patent Application 60/440,532 filed Jan. 16, 2003.

### BACKGROUND OF THE INVENTION

1. Field of Invention

This invention relates to an improved pulper or mixer rotor with increased pumping and defibering capacities, reduced power requirements, easier maintenance and interchangeability of parts, and improved wear resistance.

2. Description of Related Art

FIG. 1 shows a conventional pulping, mixing, or defibering apparatus, which generally includes a vat, or tub, 10 formed of side wall 11 and bottom wall 12. In the center of the bottom wall 12 is a perforated bed-plate 13. The bed-plate 13 permits draining of pulped paper stock, for example, after a pulping operation is completed. A rotor 15 for circulating the paper stock, for example, or other material, is mounted on a hub 14 in the center of the bed-plate 13. Supports 19 stabilize the pulping tub, or vat, 10.

The rotor 15 creates a mechanical shear and/or hydraulic shear effect on the pulp, or other material, being mixed. Mechanical shear, for example, is achieved by rotating the rotor 15 above the stationary bed-plate 13 so that the paper pulp stock, or other material, is agitated, and the fibers and liquids are approximately separated by being strained through the bed-plate 13 under the pressure applied by vanes 17 of the rotor 15. Hydraulic shear, on the other hand, occurs by contacting the paper pulp fibers, for example, with other paper pulp fibers in the tub, or vat, 10 as a result of the turbulence, or flow pattern, generated by rotation of the rotor 15. The rotor 15 is driven by gears that engage the hub 14. A motor 22 powers the gears that are housed within gear housing 20.

FIG. 2 shows a conventional pulper rotor 15 with a series of straight vanes 17 extending beyond the outer circumference of a spar ring 16. The straight vanes 17 tend to be fairly blunt and thick at a leading vane face 17a, and tapers thinner at a trailing edge 17b of each vane 17. One end of each vane 17 nearest the spar ring 16 joins an outer portion of the spar ring 16. The portions where each vane 17 joins the spar ring 16 gradually tapers to form a gulley 17c. These gulleys 17c are susceptible to cavitation wear from the turbulent flow of pulp, or other materials passing over the vanes 17 in the wake of the agitation generated by rotation of the rotor 15.

FIG. 3 shows that straight vanes 17 result in an angle of the leading edge of the vane face 17a varying relative to a radian rₙ, for example, projecting from the rotor hub 14 to the edge of the vane face 17a. As seen in FIG. 3, for example, the angle of the vane face 17a at a location nearest the spar ring 16 is 43 degrees relative to a radian r₁ projecting from the rotor hub 14 to a first edge location of the vane face 17a, whereas the angle of the same vane face 17a at an edge location furthest from the spar ring 16 is 30 degrees relative to a radian r2 similarly projecting from the rotor hub 14 to the edge of the vane face 17a. As a result of the change in angle of the vane face 17a, the vane face 17a strikes the pulp material, or other material being mixed, less consistently and with less mixing or agitation effect because the relative angle of the vane face 17a lessens as the vane 17 extends further from the spar ring 16. That is to say, the pulp material, or other material being mixed by the vane 17 by striking the vane face 17a, is less likely to be mixed with the same consistency or force by the straight vane 17 as the rotation of the rotor 15 occurs because the lessening relative angle of the vane face 17a encourages the materials being mixed to simply slide along the vane face 17a of each vane 17 and outward from the rotary path of the vanes 17. Thus, the pulp, or other material being mixed, in conventional straight vane rotor systems tend to be ineffectively directed out of contact with the vane faces 17a and out of the rotary path of vanes 17, resulting in a more time-consuming mixing of the materials being required in order to achieve a desired defibering, for example, effect. The additional mixing time due to the inefficiencies of straight vane rotors requires additional power consumption to operate the rotor until the desired defibering effect on the materials is achieved.

Further, the bluntness of the leading edge of straight vane face 17a subjects the vane faces 17a to considerable wear as mixing of materials occurs. To compensate for the wear induced by the agitation of materials on the leading edge of straight vane faces 17a, prefabricated wear plates are often separately welded onto the leading edge of the vanes 17. Such straight vane face pulper rotors 15 with welded wear plates may be relatively easy to make, however, they tend to have some of the same inefficiencies at pumping materials in desired directions or capacities due, at least partially, to the changing relative angle of contact of each vane face 17a with the pulp, or materials, being mixed as discussed above. Further, the requirement of welding wear plates onto the vanes 17 limits the materials that can be used to those compatible with the underlying material chosen for the vane. Such compatibility requirements may limit the choice of vane materials to those that are generally not the most wear-resistant type materials in order for the wear plates to be successfully welded onto the vanes. Still further, because of the welding aspect of the wear plate, it is often required to change the entire vane, at least, even when only the wear plate is all that is worn.

Moreover, straight vane face rotors can be difficult and economically inefficient to repair, replace or maintain. For example, often removal of the entire rotor is required in order to replace, repair or service just a vane or just a wear plate. The removal of an entire rotor may require additional personnel, and may result in significant inoperable time of the pulper, or mixer, in general.

To address the inefficiencies of straight vane face rotors, booster vanes 18, as shown in FIG. 2, are frequently used. Such booster vanes 18 are also typically welded to the top of the straight vanes 17 to add an additional material contacting face and to increase pumping efficiencies. The use of booster vanes 18 still does not render straight vane face rotors optimally efficient however, as the additional materials and production costs render such straight vane rotors 15 with booster vanes 18 more costly to manufacture. Further, even with booster vanes 18, some materials are already directed away from the vanes 17, in general, by the material's initial impact with the straight vane face 17a as discussed above. Such booster vanes 18 also require increased power requirements to achieve increased pumping capacities. Thus, any pumping efficiency added by the booster vanes 18 may well be offset by the added manufacturing and added operational costs incurred with straight vane rotors having booster vanes 18. Further, the introduction of yet another additional part, represented by the booster vane 18, increases the costs and time required for maintenance, repair and/or replacement, while still experiencing the inconvenience of having to remove the entire rotor 15 to perform such repair, replacement or maintenance functions. Further still, such booster vanes 18 result in the gulleys 17c being particularly susceptible to cavitation wear as a result of the increased turbulence of materials flowing in the wake of the booster vane 18 induced agitation of the pulp stock, or other material, being mixed.

As with the inefficiencies experienced by the changing angle of the vane face relative to the series of radians rₙ projecting from the rotor hub 14, straight vanes 17 also have a varying intersection angle relative to the underlying bedplate 13 of the conventional pulper rotor 15. The interface of the pulp stock, or other material, agitated by the vanes 17 of the rotor 15 and pressed downward toward the bedplate 13 results in the desired defibering, for example, of the pulp, or other materials, as the liquefied matter passes, as if strained, through apertures 13a of the bedplate 13 (see FIG. 4). Thus, because the intersection angle of the vanes 17, relative to the bedplate 13, changes as the vanes 17 extend across the bedplate 13, the pressure imposed upon the pulp stock, or other material, from the vanes 17 is not consistently applied to the materials from the inner diameter to the outer diameter of the bedplate 13. As a result, defibering efficiency is less than optimal.

The inefficiencies of such straight vane rotors with respect to pumping and defibering inefficiencies, even with booster vanes, and the susceptibility of straight vane rotors to high wear zones and maintenance, repair or replacement inconveniences, pose problems the improved pulper, or mixer rotor, as set forth herein, is designed to help overcome. Further the power consumption inefficiencies of straight vane rotors may be minimized by the improved pulper, or mixer rotor described herein which helps eliminate the need for such booster vanes, and performs similar mixing of materials in less time, while requiring less power.

### SUMMARY OF THE INVENTION

This invention provides an improved pulper, mixer or defibering, rotor having a spar ring attached to a hub of the rotor with a series of curved vanes projecting from the spar ring. The curved vanes have a constant vane face angle relative to radians immediately adjacent one another and extending outward from the hub of the rotor. As a result of the constant relative vane face angle, the pulp, or materials, mixed by the vanes of the rotor are more consistently in contact with the vanes during rotation of the rotor. Thus, booster vanes are not required. As a result, increased circulation and pumping effects with minimal power requirements are achieved.

This invention separately provides a series of curved vanes having vane faces with substantially similar, or preferably equal, surface volumes. As a result of the substantially similar, or preferably equal, vane face surface volumes, the paper pulp stock, or other materials, being mixed by the vanes in the pulper tub, or vat, remains in contact with the vane face of each vane for a prolonged period as circulation occurs.

This invention separately provides the series of curved vanes projecting from the spar ring as separately attachable to the spar ring via spar stubs. The spar stubs are made of a high strength material integral with the spar ring, whereas the separably attachable vanes are made with a highly wear-resistant material. As a result of the separably attachable nature of the vanes to the spar stubs, maintenance is easier as the vanes may be repaired or replaced without requiring removal of the entire rotor. Further because the vanes are separably attached, rather than welded, a greater variety of highly wear-resistant materials are available to form the vanes. As a result of the high strength spar ring and spar stubs, the need for additionally welded wear plates and/or booster vanes are not required, thus minimizing weight and power consumption. As a result of the highly wear-resistant material, the circulation and pumping effectiveness of the vanes and rotor continue longer, reducing the need for repair or replacement. As a further result of the separably attachable vanes, the opportunity to change configurations of the vanes to meet changing customer needs is also more readily available.

This invention separately provides vanes having an endplate feature that improve the tip suction pulse effect, which recirculates the paper pulp stock, or other material, more easily in the pulper tub, or vat, until the desired defibering, for example, is achieved.

These and other features and advantages of this invention area described in, or are apparent from, the following detailed description of various exemplary embodiments of the systems and methods according to this invention.

### BRIEF DESCRIPTION OF THE DRAWINGS

Various exemplary embodiments of the systems and methods of this invention will be described in detail with reference to the following figures, wherein:

FIG. 1 illustrates a conventional pulper;

FIG. 2 illustrates a conventional straight vane faced rotor with booster vanes;

FIG. 3 illustrates a vane face angle of a conventional straight vane faced rotor relative to a radian originating from a rotor hub;

FIG. 4 illustrates an improved rotor mounted above a perforated bed-plate according to at least one exemplary embodiment of the invention;

FIG. 5 illustrates a bottom view of an exemplary embodiment of an improved rotor according to the invention;

FIG. 6 illustrates another embodiment showing a different mounting of the vane to a spar ring;

FIG. 7 illustrates an exemplary embodiment of a single vane according to the invention;

FIG. 8 illustrates a vane face angle of the improved rotor referred to in FIG. 4 relative to a radian originating from the rotor hub;

FIG. 9 illustrates another exemplary embodiment of a spar stub and vane according to the invention;

FIG. 10 is a schematic view of a composite vane in accordance with another embodiment of the invention; and

FIG. 11 is a schematic view of another vane structure.

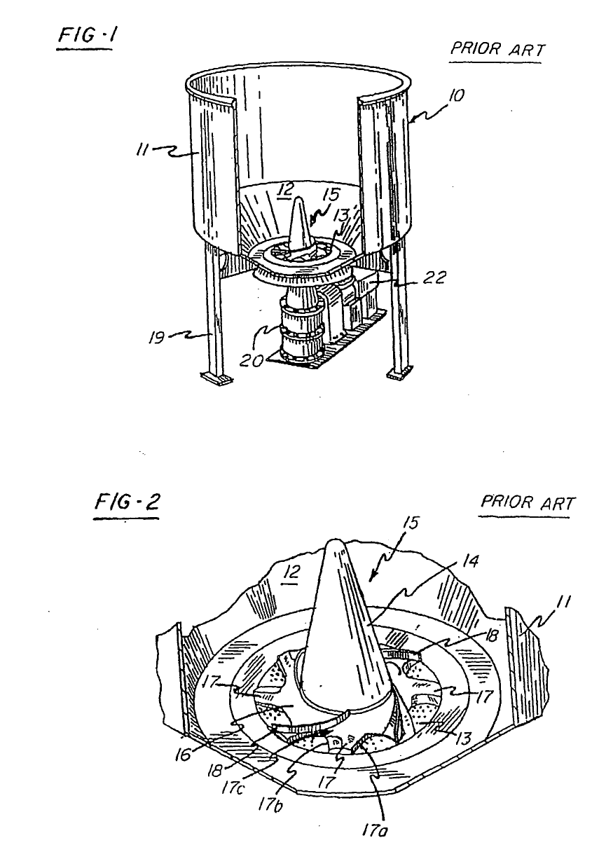

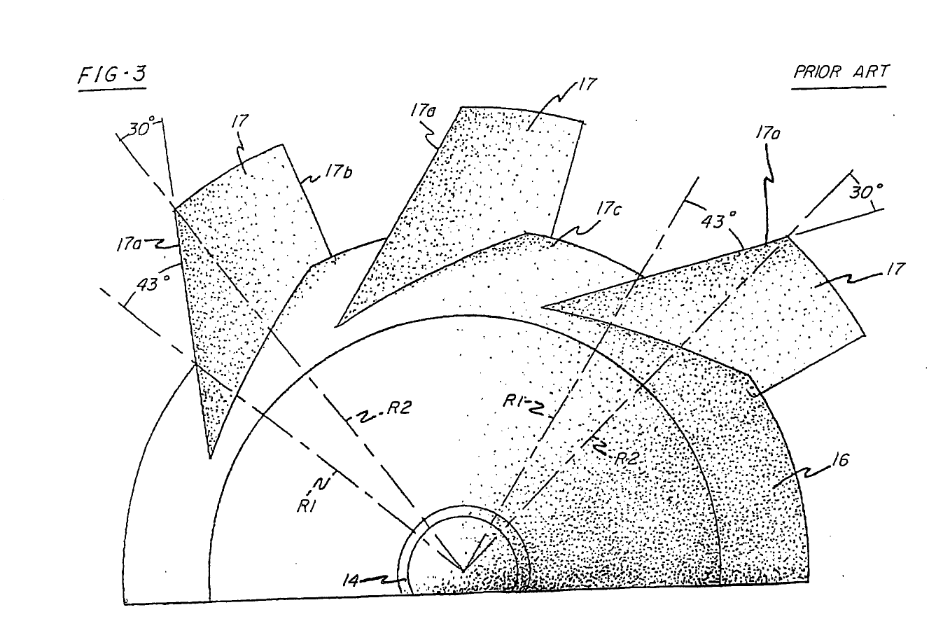

### DETAILED DESCRIPTION OF EXEMPLARY EMBODIMENTS

The conventional pulper tub, or vat, 10 shown in FIG. 1 shows generally the type of pulper tub, or vat, 10 with which the various exemplary embodiments of the improved pulper, mixing or defibering, rotor 35 of the invention described herein is intended to be used. Accordingly, like numerals are used, where possible, in describing the various exemplary embodiments of the invention when referring to features translatable with those of the conventional pulper of FIG. 1.

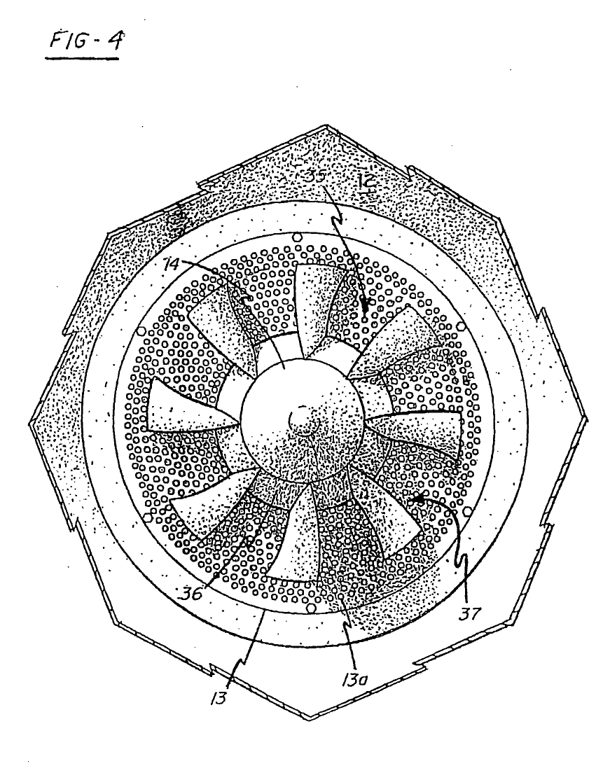

FIG. 4 shows one exemplary embodiment of the improved pulper, mixer or defibering, rotor 35 of the invention. The pulper, mixer or defibering, rotor 35 includes a spar ring 36 that supports a plurality of vanes 37. The vanes 37 extend generally radially outwardly from the spar ring 36 towards an outer circumference of the perforated bed-plate 13. The spar ring 36 is mounted about a hub 14 at the center of the bed-plate 13. The pulper, mixer or defibering, rotor 35 may be driven by a conventional gearing and motor 22 combination, as generally depicted in FIG. 1. Rotation of the vanes 37 of the pulper, mixer or defibering, rotor causes paper pulp stock, for example, or other material, to circulate in the tub, or vat, 10. The circulation of the stock, or other materials, helps achieve the hydraulic shearing effect among the circulating stock, or other materials, as well as the mechanical shearing effect on the stock, or other materials, via the interaction of the rotating vanes 37 against the stationary bed-plate 13 at a bottom of the pulper tub, or vat, 10. Once the fibers of the paper pulp stock, or other material, are sufficiently broken down, or defibered, for example, the materials pass through apertures 13a of the bed-plate 13.

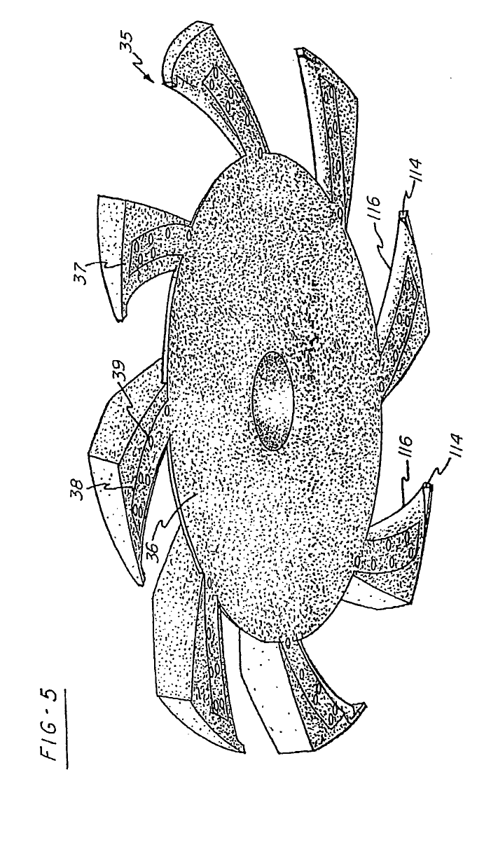

FIG. 5 illustrates the underside of an exemplary embodiment of the pulper, mixer or defibering, rotor 35. The vanes 37 are demountably attachable to spar stubs 38 extending from the spar ring 36. The spar stubs 38 may be made integrally with the spar ring 36 as shown in FIG. 5. Alternatively, the spar stubs 38 may be separably attached, for example welded, to the spar ring 36 as shown in FIG. 4. In any event, the spar stubs 38 project, at designated intervals, from an outer circumference of the spar ring 36. The spar stubs 38 may be made of the same material as the spar ring 36, or of a different material, in order to provide similar strength and a high degree stability between the spar stubs 38 and spar ring 36.

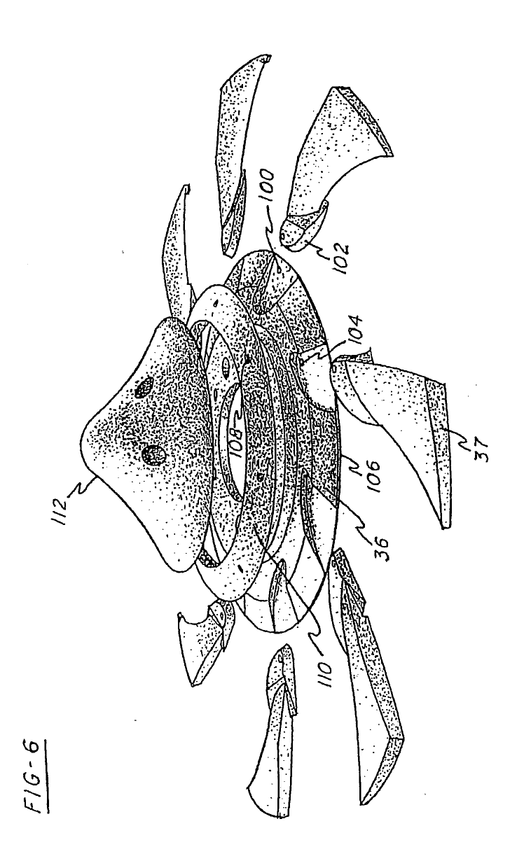

The spar stubs 38, of the exemplary embodiment shown in FIG. 5, include attachment devices 39 for securing the vanes 37 to the spar stubs 38. The attachment devices may be any of screws, rivets, projections, or other such structures for securing the vanes 37 to the spar stubs 38. It is noted that those skilled in the art may fashion other coupling arrangements besides the projection/spar stubs 38 that may be received in female grooves or the like shown. For example, the vanes 37 could be designed to have male projections on their i.d. ends adapted for receipt in female concavities provided in appropriate locations on the spar ring 36. One such alternative coupling design is shown in FIG. 6. Here, specifically configured female slots 100 are provided around the periphery of spar ring 36. Mating male ends 102 of the vanes 37 are snugly fitted in the slots and the joint can be further secured by bolts or the like (not shown) that would be inserted through registered bores 104, 106 placed respectively in the female and male parts, and corresponding apertures 108 of the clamp ring 110. A rotor cap 112 is attached over the assembly to secure to the clamp ring.

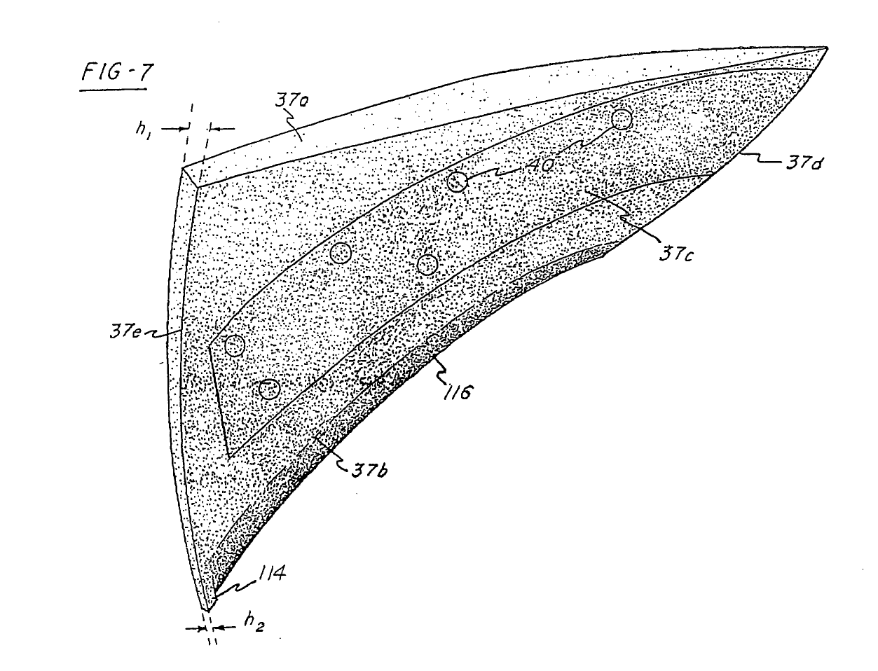

FIG. 7 illustrates an exemplary embodiment of a vane 37. The vane 37 is separably attachable to the spar stubs by attachment devices 40 corresponding to the attachment devices of the spar stubs. Each vane 37 includes a vane face 37a on the leading edge, a trailing edge 37b and a spar stub mounting surface 37c. The vane face 37a is provided with a designated vane height h1. The vane height h1 at the vane face 37a tapers to a vane height h2 at the trailing edge 37b of the vane 37. The pitch angle of the vane face 37a is preferably constant, for example at 30°, to provide a desired pressure to the paper pulp stock, or other materials, being mixed by contact with the vane face 37a of the vane 37 upon rotation. The vane 37 may be slid onto the spar stub 38 (see FIG. 5) in order to align the spar stub mounting surface 37c of the vane 37 so that the corresponding attachment devices are aligned to secure the vane 37 to the spar stub 38, and the innermost vane surface 37d abuts the spar ring 36 (FIG. 4). The outermost vane surface 37e of the vane 37 is generally curved from the vane face 37a to the trailing edge 37b. The interface of the trailing edge 37b and outermost vane surface 37e of the vane 37 provides a lifting effect that sucks fiber off from the stock, or other materials, being mixed by rotation of the rotor 35. Note also in FIG. 7 that the trailing edge of the vane comprises a curved edge 116 radiused downwardly toward the bed-plate surface. This too helps to provide a suction pulse that cleans the bed-plate. Further protruding end dam member 114 is provided along the o.d. extremity of the trailing edge. The end dam doesn't allow flow to “leak” off the end of the rotor; thereby improving suction and bed-plate cleaning across the entire swept area.

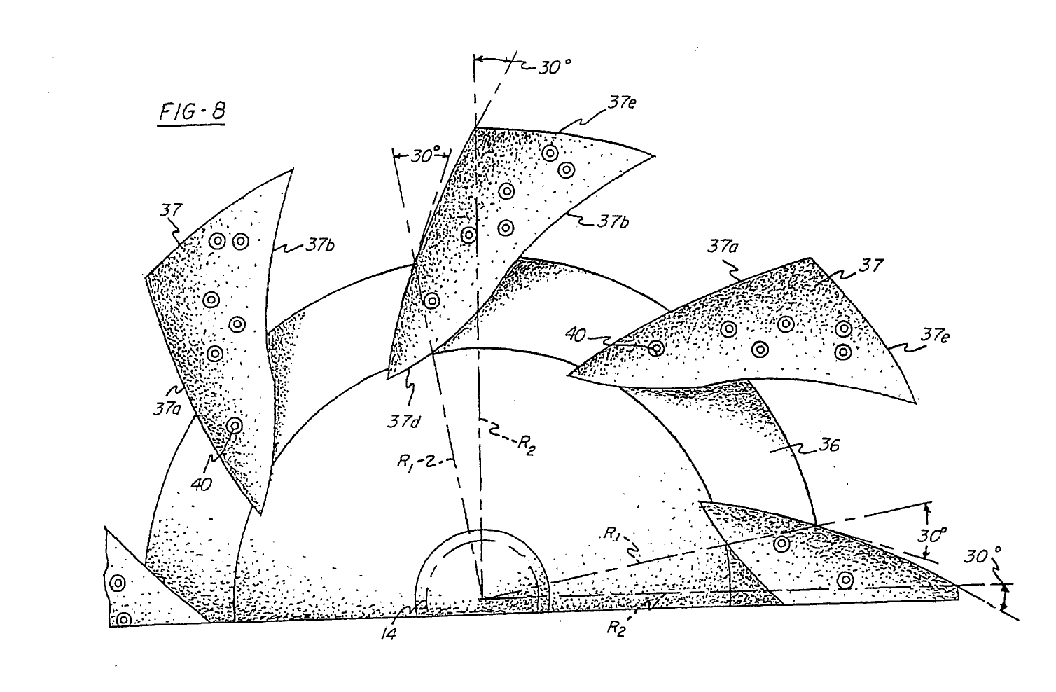

FIG. 8 shows generally, according to the various exemplary embodiments of the invention, a configuration of the vanes 37 mounted to the spar ring 36 by attachment devices 40. The vanes 37 are mounted such that the angle between the vane face 37a and a radian r₁ extending from the center of the hub 14 towards the outermost circumference of the spar ring 36 is substantially the same as the angle between the vane face 37a and any other radian, for example r₂, similarly extending from the center of the hub 14 and toward the outermost circumference of the spar ring 36 or the outermost vane surface 37e. By substantially the same we mean that the difference in vane face surface to intersecting radian angle for any two points along the vane face surface should not exceed greater than about 10°. By controlling the angle of the vane face 37a relative to the spar ring 36, more constant contact of the paper pulp stock, or other materials, being mixed is achieved upon rotation of the rotor 35 and vanes 37. Further, because the vanes 37 may be separably attached to the spar ring 36 by mounting to the spar stubs 38 (FIG. 5), the vanes 37 may be made of a greater variety of materials, such as ceramics, urethanes, or other highly wear resistant and durable materials that previous straight vane faced rotors, for example, were not able to be made of.

Of course, it should be appreciated that the angles of each of the vane faces 37a are not limited to uniformity, rather, the angle of the vane face 37a of each vane may be varied to accomplish the desired contact with the stock, or other materials, being mixed. Likewise, the contour or shape of the vanes 37 may be varied even though mounted on the same spar ring 36, such that one vane 37 may be smooth, and another vane 37 may be toothed, for example, or otherwise not smooth, in order to achieve different pulping, mixing or defibering, actions. Similarly, vanes 37 of different lengths may be mounted on the same spar ring 36 to achieve different pulping, mixing or defibering, actions as well.

Certain advantages of the various exemplary embodiments of the rotor 35 using the separably mounted vanes 37 of the invention versus standard, or conventional, rotors may occur. For example, the various exemplary embodiments of the rotor 35 and vanes 37 will achieve the same thrust (Th) using significantly less horsepower (hp) than standard, or conventional, rotors. As a result, not only will more stock, or other materials, be in contact with the vane face 37a of the vanes 37, as described with reference to FIG. 7, for example, but the efficiency of the pulping, mixing or defibering will be increased as well while less power will be used as evidenced by higher thrust/horsepower ratios (Th/hp) than conventional designs. Additionally, a greater volume, or quantity, of stock, or other materials, may be pulped, mixed or defibered per unit time (sec) as would be evidenced by the quantity to time ratio (Q).

Thus, not only are the various exemplary embodiments of the separably attached vanes more efficient, they also are more durable and wear resistant due to the choice of materials available to comprise each vane 37. Moreover, even were replacement or repair of the vanes 37 required, such replacement or repair is relatively easy as the rotor 35 may be left in the pulper tub, or vat, 10, for example, whereas prior art conventional rotors require the complete removal of the rotor in order to work only on the vanes, or other vane related components, for example.

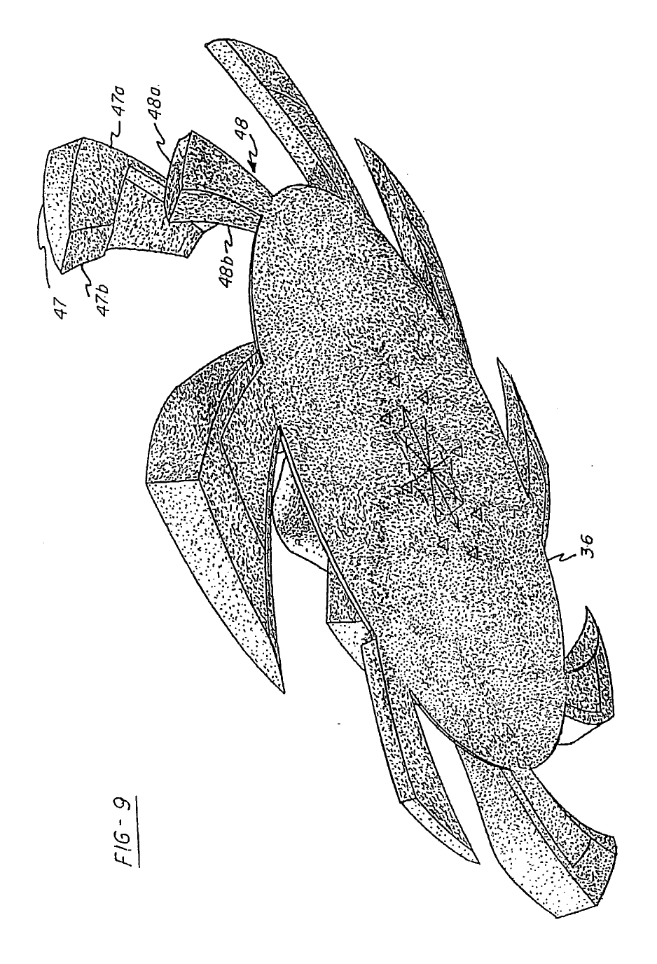

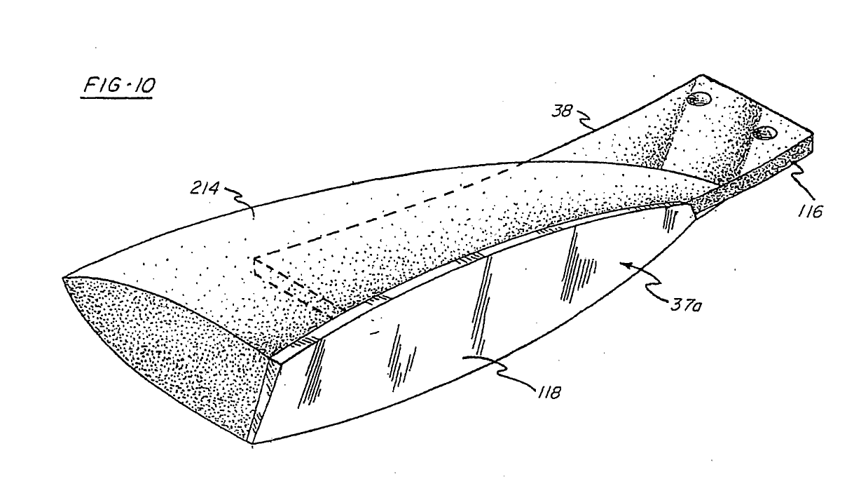

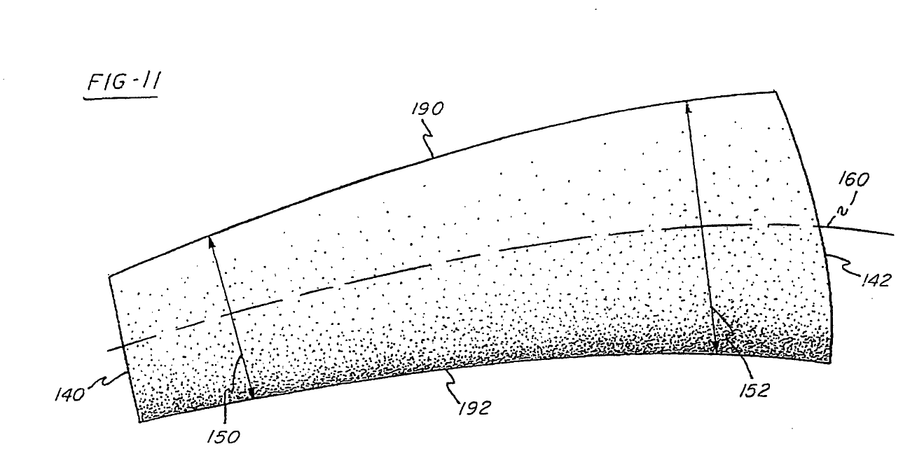

FIG. 9 illustrates another exemplary embodiment of the vanes 47 according to the invention. The vanes 47, according to the exemplary embodiment shown in FIG. 10 differ from the vanes 37 shown in FIG. 7, which illustrate vanes 37 having a continuous trailing edge 37b extending from the innermost vane surface 37d to the outermost vane surface 37e and integral with each vane 37. As a result, the vanes 37 are mounted by sliding over the spar stubs 38, in a generally perpendicular direction relative to the spar ring 36, towards the spar ring 36. The exemplary embodiment of the vanes 47 shown in FIG. 9, on the other hand, provides spar stubs 48 joined at one end to the spar ring 36 and having an outer end 48a opposite the spar ring 36. Each spar stub includes a first trailing edge portion 48b extending from the spar ring 36 to an outer end 48a of the spar stub 48.

A vane 47 having a vane face 47a and a second trailing edge portion 47b is slidingly mounted over each spar stub 48, in a generally lateral direction relative to the spar ring 36, such that the first trailing edge portion 48b of the spar stub 48, and the second trailing edge portion 47b of the vane 47, are immediately adjacent one another to form the equivalent of the unified trailing edge 37b of the exemplary embodiment described with reference to FIG. 7 above. Once aligned appropriately over the spar stub 48, the vane 47 is attached to the spar stub 48 in a manner as described with reference to the exemplary embodiments discussed above.

The vanes 47 of the exemplary embodiment illustrated in FIG. 9 have vane faces 47a of a constant pitch angle such that the stock, or other materials, being mixed are more readily contacted by the vane face 47a as the rotor 35 and vanes 47 rotate. Likewise, the vane 47 tapers from a height h1 at the vane face 47a to a height h2 at the combined trailing edge formed of first trailing edge portion 48b and second trailing edge portion 47b.

The vanes 47 thus provide similar advantages to those described with reference to the exemplary embodiments discussed above. Such advantages include the greater choice of materials to form the vanes 47, more flexibility in the arrangement of vanes 47 on the spar ring 36, greater contact area and contact time of the materials being mixed with the vane face 47a, decreased power requirements, and easier accessibility for maintenance and repair of the vanes 47.

An alternative vane structure is shown in FIG. 10. Here, the face 37a of the vane comprises a wear plate 118 made of a hard metal that is, for example, investment cast to the desired shape. The trailing body section 214 of the vane may be formed from a filler/bonding material. As shown, spar stub 38 is partially in phantom and includes a male mounting end 116 adapted for reception in a female recess or the like in the spar ring (not shown). The body section 214 may hold the face plate and spar stub 38 together and provide the required hydraulic profile. Body section 214 may be composed of an urethane/epoxy but could also be a bi-metal cast process.

FIG. 11 illustrates another unique aspect of the invention. Here, the id. surface of the vane is shown at 140 with the o.d. surface depicted as 142. One inner length of the vane shown at 150 is shorter than an outer vane length shown at 152. The vane length in this embodiment increases progressively from inner vane location toward outer vane location. In operation, this vane length/section increases as the peripheral shield of the vane location increases to improve performance and reduce drag.

It is apparent that the vane member shown in FIG. 11 is streamlined to enhance operational performance. The vane member is adapted for radial disposition on a hub or the like in a pulp and paper apparatus. The vane member is rotatable around a central axis that extends through the hub and the vane has an inner-end adapted for positioning adjacent to the hub at an opposing outer edge at an outer radially directed extremity of the vane. The vane comprises a leading edge 190 and a trailing edge 192. The vane lengths are shown at 150 and 152 and they are defined as the distance between the leading edge and the trailing edge at given points along a continuum 160 that extends in the radial direction from the inner-end of the vane to the outer-end. In accordance with this aspect of the invention, the vane length increases as one proceeds along the continuum from the inner-end to the outer-end.

In operation, with any of the exemplary embodiments of the improved pulper, or mixer, rotor 35 described herein, including the spar ring 36, spar stubs 38 or 48, and vanes 37 or 47, paper pulp stock, or other material, is placed into the pulper tub, or vat, 10. The motor 22 is then operated to drive the gear 20. The gear 20 engages the hub 14, to which rotor 35 is mounted. The rotation of the rotor 35 therefore causes the vanes 37 or 47 to rotate in a direction such that the vane face 37a or 47a contacts the stock, or materials, initially. As rotation of the rotor 35 and vanes 37a or 47a occurs, more consistent contact of the stock, or materials, with the vane face 37a or 47a is maintained resulting in increased agitation and mixing of the materials. In addition, the trailing edge 37b, or the combined first trailing edge portion 48b of the spar stub 48 with the second trailing edge portion 47b of the vane, helps lift fibers, for example, from the stock, or materials, being mixed such that defibering is achieved. The defibered materials, for example, are then passed through the apertures 13a (FIG. 4) in the bed-plate 13 underlying the rotor 35 at the bottom of the tub, or vat, 10.

In summary, one aspect of the invention is directed toward the combination of demountable vane members that are adapted to be mounted over and carried by the spar stubs with the spar stubs being fixed to the annular spar ring by welding or the like. The demountable vanes may be composed of any one or more of a variety of wear resistant materials such as for example, wear resistant initial such as “stellite”, cast cobalt alloys, polyurethanes, even ceramic materials.

In another aspect of the invention, each of the leading surfaces of the vanes presents a substantially constant angle relative to at least two radians that extend from the rotor axis to any two points located along that leading cage. By “substantially constant”, we mean that this angle should not vary by more than about 10°. It is generally desirable than this angle, as measured between the axis and to a point or tangent along the leading edge should be between about 10° to about 60°, preferably about 300 to about 40°. In many cases, it will be advantageous if each of the vanes (and their corresponding leading edges) possesses this same leading edge angle.

While the invention has been described with reference to the exemplary embodiments set forth herein, it should be appreciated that other alternatives, combinations, modifications and variations are apparent to those skilled in the art. Accordingly, the preferred embodiments of this invention, as set forth above, are intended to be illustrative only, and not limiting. Various changes can be made without departing from the spirit and scope of this invention.

1. Apparatus for pulping paper pulp comprising a rotor having a central hub and an annular ring surrounding said hub, vane members extending radially outwardly from said annular ring and being demountably attached to said ring.

2. Apparatus as recited in claim 1 wherein said vane members and said ring comprise complementary coupling means for demountably attaching said vane members to said ring.

3. Apparatus as recited in claim 2 wherein said coupling means comprise cooperating male and female members.

4. Apparatus for pulping paper pulp comprising a rotor having a central hub and an annular spar ring surrounding said hub, said spar ring carrying a plurality of spar stubs fixedly connected to said annular spar ring, a plurality of vane members, each said vane member being demountably attached to one of said spar stubs.

5. Apparatus for pulping a paper pulp suspension, said apparatus comprising a rotor adapted for rotation around a central axis, said rotor carrying a plurality of vane members, each of said vane members extending generally radially outwardly relative to said axis, each said vane member comprising a leading edge adapted to lead said vane, upon rotation thereof, through said suspension, said leading edge of at least one of said vanes having a face surface with a plurality of points disposed along said surface, said face surface exhibiting a substantially constant angle relative to radians extending from said axis to any two of said points.

6. Apparatus as recited in claim 1 wherein said substantially constant angle is within a range of about 10° to about 60°.

7. Apparatus as recited in claim 6 wherein said constant angle is within a range of about 30°-40°.

8. Apparatus for pulping a paper pulp suspension, said apparatus comprising a rotor adapted for rotation around a central axis, said rotor carrying a plurality of vane members, each of said vane members extending generally radially outwardly relative to said axis, each said vane member having a leading edge adapted to lead said vane upon rotation thereof, through said suspension, said leading edges of each of said vanes having a face surface with a plurality of points disposed along said face surface, said face surface of each vane exhibiting a substantially constant angle relative to radians extending from said axis to any two points along said vane.

9. Apparatus as recited in claim 5 wherein of each said vanes exhibits the same substantially constant angle.

10. A rotor mounted on a hub, the rotor comprising:
a circular spar ring having an outer circumference, the spar ring being mounted on the hub and being comprised of a first material;
a series of spaced apart spar stubs having an inner end and an outer end, the inner end of each spar stub adjoining the outer circumference of the spar ring such that the spar stub extends from the outer circumference of the spar ring to the outer end of each respective spar stub, and a first side edge opposite a second side edge; and
a series of vanes separably attachable to a corresponding one of the series of spar stubs, wherein each vane has a vane face with a constant vane face angle relative to radians extending from the hub to a respective vane face, and each vane has a trailing edge opposite each vane face.

11. The rotor of claim 10, wherein the spar stubs are made integral with the spar ring and are comprised of the same first material as comprises the spar ring.

12. The rotor of claim 10, wherein the spar stubs are separably attachable to the spar ring.

13. The rotor of claim 12, wherein the spar stubs are comprised of the same first material as comprise the spar ring.

14. The rotor of claim 12, wherein the spar stubs are comprised of second materials different than the first material comprising the spar ring.

15. The rotor of claim 10, wherein the vanes are slidably attachable to corresponding spar stubs in a direction from the outer end of a respective spar stub to the outer circumference of the spar ring.

16. The rotor of claim 10, wherein each spar stub further comprises a first trailing edge portion extending partially along a respective spar stub from the outer end of the respective spar stub towards, but not to, the outer circumference of the spar ring.

17. The rotor of claim 16, wherein the outer trailing edge portion of each vane comprises an end dam.

18. The rotor of claim 16, wherein the first trailing edge portion is comprised of the same material as comprises the respectively corresponding vane and second trailing edge portion.

19. The rotor of claim 17, wherein the vanes are slidably attachable to corresponding spar stubs in a generally lateral direction relative to the spar ring, from the first side edge of each respective spar stub to the second side edge having the first trailing edge portion of each respective spar stub and vane immediately abut one another and form a trailing edge.

20. The rotor of claim 10, wherein the vanes are comprised of hardened metallic materials.

21. The rotor of claim 10, wherein the vanes are comprised of non-metallic materials.

22. A method of separating materials, comprising:
providing a tub having an apertured bed-plate, a rotor mounted above the bed-plate, the rotor having vanes, each vane having a constant vane face angle relative to radians extending from the hub to a respective vane face, and each vane having a trailing edge;
supplying materials to be separated into the tub;
rotating the vanes;
maintaining contact with the materials on each vane face to separate desired portion of the materials from undesired portions of the materials;
passing the materials over each trailing edge to generate increased hydraulic suction and separation of the desired portions of the materials from the undesired portions of the materials; and
urging the desired portions of materials out of the tub through the apertured bed-plate.

23. The method of claim 22, wherein each vane is separably attachable to said hub.

24. The method of claim 22, wherein each vane is comprised of wear resistant, metallic materials.

25. The method of claim 22, wherein each vane is comprised of wear resistant, non-metallic materials.

26. Vane member adapted for rotational movement about a central axis in a pulping apparatus, said vane member comprising a leading edge, a trailing edge, and a body between said leading edge and said trailing edge, said leading edge comprising a face plate, said face plate composed of a metallic material.

27. Vane member as recited in claim 26 wherein said body is composed of an urethane/epoxy material.

28. Vane member as recited in claim 26 wherein said body is comprised of a metallic material different from said face plate metallic material.

29. Vane member adapted for radically disposed orientation on a hub in a pulp and paper apparatus and being rotatable around a central axis extending through said hub, said vane having an inner end adapted for positioning adjacent said hub and an opposing outer edge at an outer radically directed extremity of said vane, said vane comprising a leading edge and a trailing edge, a vane length being defined as the distance between said leading edge and said trailing edge at any given point along a continuum extending from said inner end to said outer edge, said vane length increasing as measured along said continuum proceeding from said inner end to said outer edge.

30. Vane member as recited in claim 29 further comprising an end dam positioned on said trailing edge adjacent said outer edge.
